(19) United States
(12) Patent Application Publication
(10) Pub. No.: US 2017/0346691 A1
(43) Pub. Date: Nov. 30, 2017

(54) NETWORK TOPOLOGY OPTIMIZATION

(71) Applicant: ARIA NETWORKS LIMITED, Bath (GB)

(72) Inventors: John CRICKETT, Chippenham Wiltshire (GB); Jay PERRETT, Chippenham Wiltshire (GB); Andrea CELLETTI, Chippenham Wiltshire (GB)

(21) Appl. No.: 15/531,269

(22) PCT Filed: Nov. 27, 2015
(86) PCT No.: PCT/GB2015/053644

§ 371 Date: May 26, 2017

(30) Foreign Application Priority Data
Nov. 28, 2014 (GB) 1421157.7

(51) Int. Cl. H04L 12/24

(52) U.S. Cl. CPC H04L 41/0823; H04L 41/12

(57) ABSTRACT

Methods and systems for generating a network topology that satisfies one or more service requirements under one or more constraints. The method comprises generating a set of candidate network topologies from a set of network resources, evaluating each of the candidate network topologies based on one or more constraints and one or more service requirements, and determining if a stop condition is satisfied. If the stop condition is not satisfied then the set of candidate network topologies is updated. If, however, the stop condition is satisfied then the best candidate network topology based on the evaluation is selected as the network topology.

### BACKGROUND

Networks are typically optimized by determining the best route for satisfying each service requirement of the network (e.g. the best route for transferring data between points of the network). Individual optimization of service requirements, however, provides only a piecemeal solution to network optimization since it does not optimize the network as a whole for all of the service requirements simultaneously.

An analogy can be made to de-fragmenting a computer's memory. As is known to those of skill in the art defragmenting involving finding files in memory that are fragmented, finding a place elsewhere in memory to fit that file, copying the file to the new location and deleting the original file. If you do de-fragmenting piecemeal on a per file basis you get gaps in the memory that can't be properly used. Similarly, if you do network optimization on a per service requirement basis instead of holistically for all service requirements, you don't achieve a network that is optimal for the services requirements as a whole.

Accordingly there is a desire for a system and method for optimizing the topology of a network for all service requirements under one or more constraints.

The embodiments described below are not limited to implementations which solve any or all of the disadvantages of known network optimization systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

Described herein are methods and systems for generating a network topology that satisfies one or more service requirements under one or more constraints. The method comprises generating a set of candidate network topologies from a set of network resources, evaluating each of the candidate network topologies based on one or more constraints and one or more service requirements, and determining if a stop condition is satisfied. If the stop condition is not satisfied then the set of candidate network topologies is updated. If, however, the stop condition is satisfied then the best candidate network topology based on the evaluation is selected as the network topology.

A first aspect provides a system to generate a network to support a plurality of service requirements, the system comprising: a candidate generation module configured to generate a set of candidate network topologies from a set of network resources, and repeatedly evolve the set of candidate network topologies; a candidate evaluation module configured to repeatedly evaluate each of the candidate network topologies based on one or more user-specified technical constraints and the plurality of service requirements, each service requirement indicating an amount of data to be transmitted from a start node to an end node; a stop condition module configured to repeatedly determine if a stop condition is satisfied, and in response to determining the stop condition is satisfied select the best candidate network topology from the set of candidate network topologies based on the evaluation of the candidate network topologies and output the selected candidate network topology; and means for generating a network having the output network topology.

A second aspect provides a system to determine an optimum network topology to support a plurality of service requirements, the system comprising: a candidate generation module configured to generate a set of candidate network topologies from a set of network resources, and repeatedly evolve the set of candidate network topologies; a candidate evaluation module configured to repeatedly evaluate each of the candidate network topologies based on one or more user-specified technical constraints and the plurality of service requirements, each service requirement indicating an amount of data to be transmitted from a start node to an end node; and a stop condition module configured to repeatedly determine if a stop condition is satisfied, and in response to determining the stop condition is satisfied select the best candidate network topology from the set of candidate network topologies based on the evaluation of the candidate network topologies and output the selected candidate network topology as the optimum network topology.

A third aspect provides a method to generate a network to support a plurality of service requirements, the method comprising: generating, using a computer, a set of candidate network topologies from a set of network resources; repeatedly evaluating, using the computer, each of the candidate network topologies based on one or more user-specified technical constraints and the plurality of service requirements, each service requirement indicating an amount of data transmitted from a start node to an end node; repeatedly determining, using the computer, if a stop condition is satisfied; in response to determining the stop condition is not satisfied, evolving, using the computer, the set of candidate network topologies; in response to determining the stop condition is satisfied, selecting, using the computer, the best candidate network topology from the set of candidate network topologies based on the evaluation of the candidate network topologies; outputting the selected candidate network topology; and generating a network having the outputted network topology.

A fourth aspect provides a computer-implemented method to determine a network topology to support a plurality of service requirements, the method comprising: generating a set of candidate network topologies from a set of network resources; repeatedly evaluating each of the candidate network topologies based on one or more user-specified technical constraints and the plurality of service requirements, each service requirement indicating an amount of data transmitted from a start node to an end node; repeatedly determining if a stop condition is satisfied; in response to determining the stop condition is not satisfied, evolving the set of candidate network topologies; in response to determining the stop condition is satisfied, selecting the best candidate network topology from the set of candidate network topologies based on the evaluation of the candidate network topologies; and outputting the selected candidate network topology.

A fifth aspect provides a computer readable storage medium having encoded thereon computer readable program code which when run by a computer causes the computer to perform the method of the fourth aspect.

The methods described herein may be performed by a computer configured with software in machine readable form stored on a tangible storage medium e.g. in the form of a computer program comprising computer readable program code for configuring a computer to perform the constituent portions of described methods or in the form of a computer program comprising computer program code means adapted to perform all the steps of any of the methods described herein when the program is run on a computer and where the computer program may be embodied on a computer readable storage medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

The hardware components described herein may be generated by a non-transitory computer readable storage medium having encoded thereon computer readable program code.

This acknowledges that firmware and software can be separately used and valuable. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of an example network topology;

FIG. 2 is a schematic diagram of an example optimization of the network topology of FIG. 1 under a protection constraint;

FIG. 3 is a schematic diagram of an example optimization of the network topology of FIG. 1 with no protection constraint;

FIG. 4 is a block diagram of an example system for optimizing the topology of a network;

FIG. 5 is a flow diagram of an example method of optimizing the topology of a network using the system of FIG. 4;

FIG. 6 is a schematic diagram illustrating generation of a set of candidate network topologies;

FIG. 7 is a schematic diagram of example demand matrix;

FIG. 8 is a schematic diagram illustrating a method of allocating bandwidth values to a candidate network topology;

FIG. 9 is a schematic diagram of an example set of constraints;

FIG. 10 is a schematic diagram illustrating calculation of the fitness value for a candidate network topology;

FIG. 11 is a flow diagram of an example method for evolving the set of candidate network topologies;

FIG. 12 is a schematic diagram illustrating a method of generating child candidate network topologies through mating;

FIG. 13 is a schematic diagram illustrating a method of generating child candidate network topologies through mutation;

FIG. 14 is a chart illustrating an example stop condition; and

FIG. 15 is an example computing-based device.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

Described herein are methods and systems for identifying an optimum network topology to satisfy one or more service requirements under one or more constraints. Each service requirement defines an amount of data or information transferred from one node of the network to another.

The term “network” is used herein to mean any interconnection of elements for the transfer of data or information. A network may comprise a plurality of physical objects, such as a network of IP (Internet Protocol) routers, a telephone communications system, a utility distribution system or a network of blood vessels. Alternatively, a network may comprise a plurality of abstract objects, such as a data flow or social interactions. The topology of a network defines the specific interconnections or links between the objects of the network.

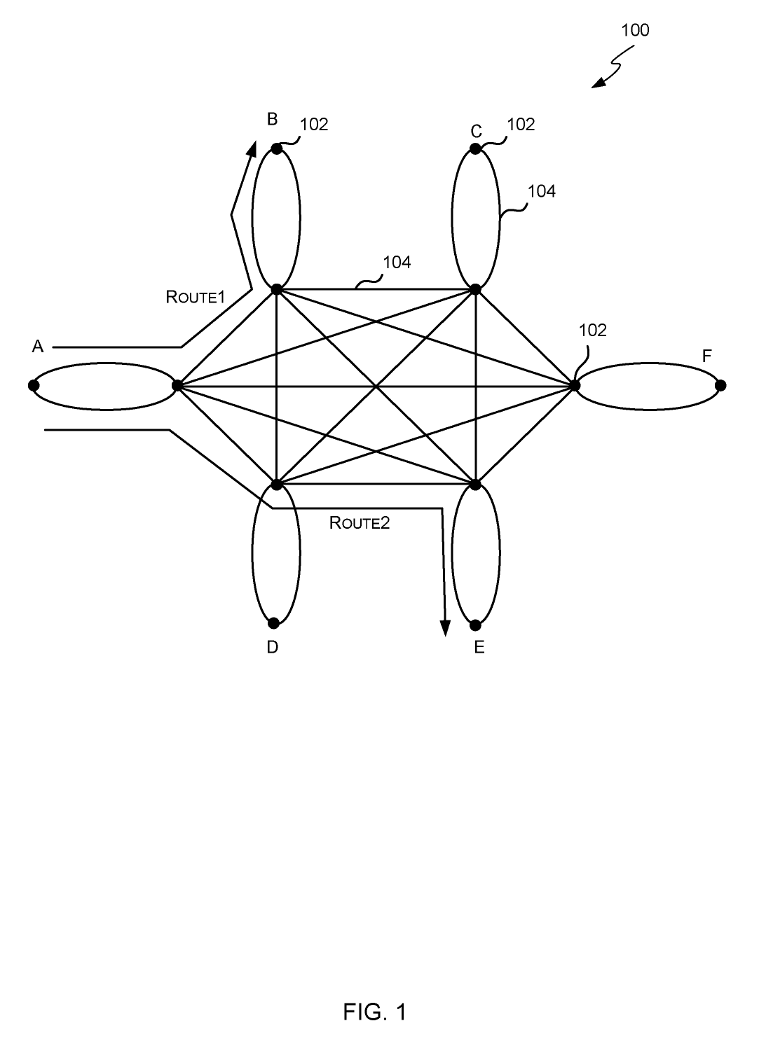

Reference is first made to FIG. 1 which illustrates an example network topology 100. The network topology 100 comprises a number of nodes 102 and links 104 that connect the nodes 102. Each node represents a terminal point or intersection point of a network. A node may be, for example, a topology element such as a location in a network; a system; a physical element such as a router, switch terminal, hub, branch, intersection or the like; or a virtual element such as a channel.

Each link 104 provides a connection between two nodes. A link may be, for example, a physical element such as a cable, pipe or road; an abstract element such as a network link; or a virtual element such as a channel or frequency of a link or cable. Each link is typically associated with a capacity or bandwidth that defines the amount of data that can be transferred between the two nodes connected via the link.

When a network engineer is designing a new network he/she typically starts with a list of the potential nodes in the network, the potential links between those nodes, and a set of service requirements (e.g. a definition of traffic to be transferred between nodes). The objective is to select the best network topology to satisfy the service requirements. Typically this is done by identifying the best route (e.g. combination of potential links) to satisfy each of the service requirements and then building a network topology that comprises each link specified as being part of a best route for at least one of the service requirements.

As described above, the problem with using this method to design a network topology is that while it may provide the best solution (e.g. best route) for each individual service requirement, it often does not provide the best overall network topology for the service requirements as a whole. For example, where the best route between nodes A and B is Route 1 shown in FIG. 1 and the best route between nodes A and E is Route 2 shown in FIG. 1 a network topology may be developed that comprises all of the links forming Routes 1 and 2. However, the overall network topology may be better optimized (e.g. based on one or more constraints) by, for example, connecting nodes A and E via the diagonal link that runs through the center instead of using the links forming Route 2.

However, people in the art do not normally think of optimizing the topology as a whole but instead tend to focus on optimizing services instead. This is because it is much easier to move a service than it is to create/move a link. It is also difficult to visualize the topology of a network other than when the network is on a trivial scale. For example, in a network with hundreds of nodes and links it is difficult to see the path between nodes, let alone the best path between nodes. Accordingly, if one attempts to design a network topology by starting with all the potential links that could form that network the problem of identifying the best path and thus the best topology is intractable by hand.

To address this issue, described herein are systems and methods for selecting an optimum network topology to satisfy a set of service requirements as a whole based on one or more constraints. Accordingly, instead of focusing on optimizing the individual service requirements the focus is optimizing the network topology as a whole. In some cases the methods and systems described herein comprise selecting an optimum network topology using an iterative process. The iterative process comprises selecting a number of candidate network topologies from the possible network topologies, evaluating the candidate network topologies to determine if a stop condition has been met, if the stop condition has not been met refining the list of candidate topologies and then repeating.

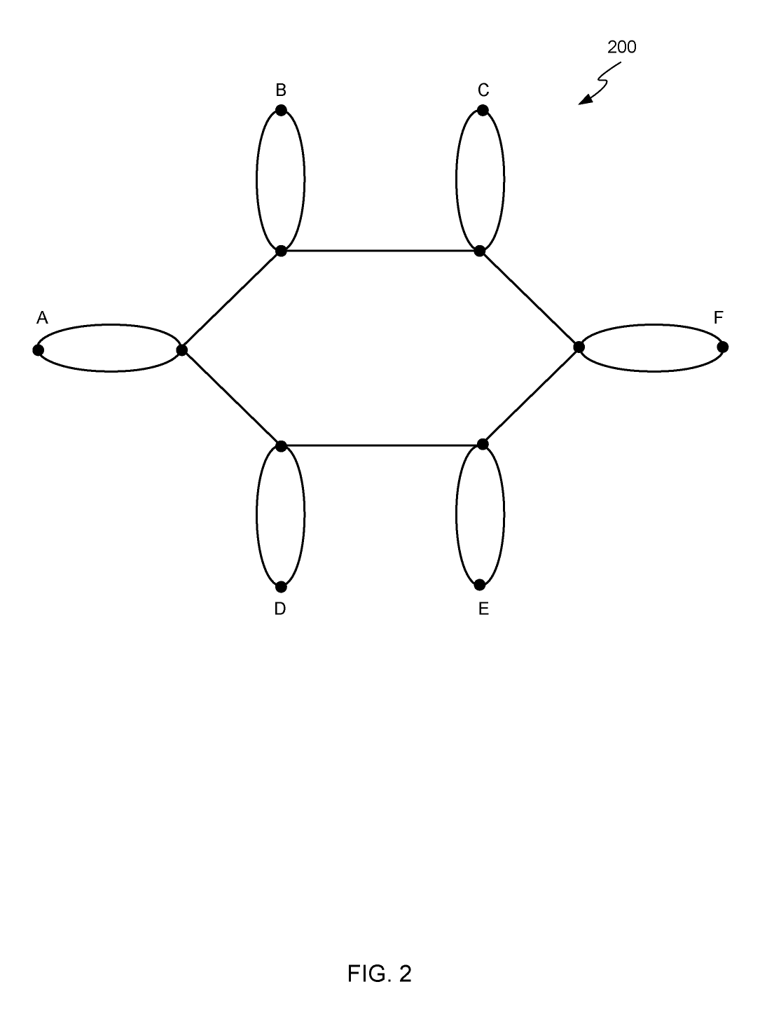

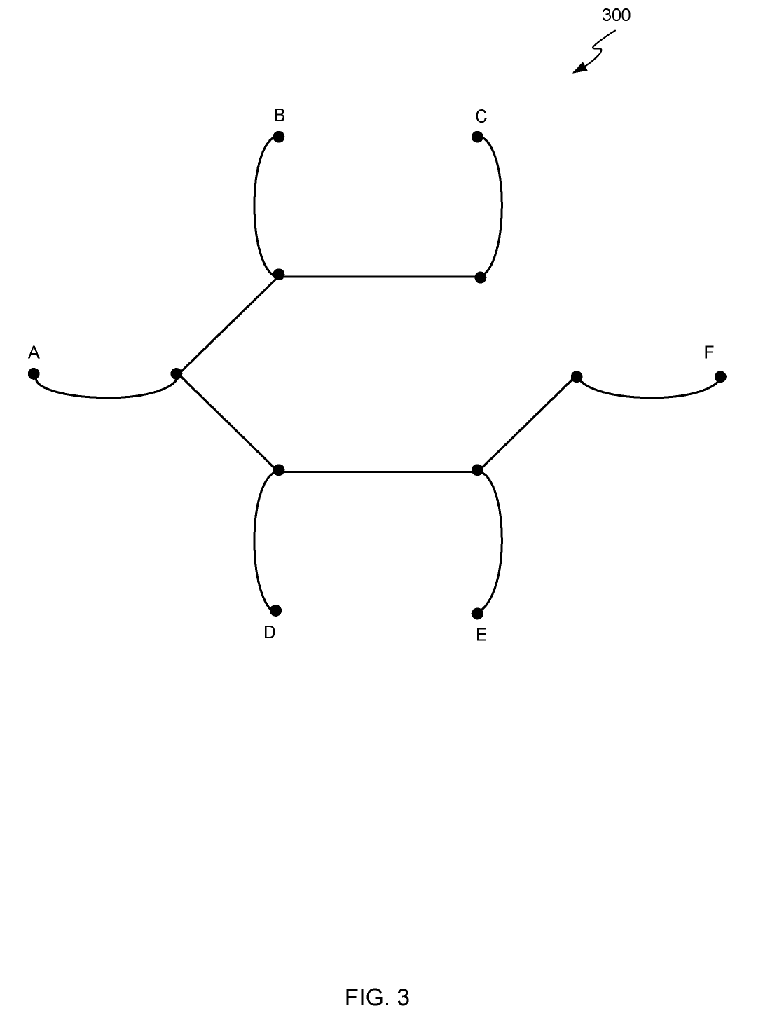

Ideally the systems and methods described herein produce an optimum network topology for a set of service requirements based on one or more constraints. For example, if the service requirements specify that there will be traffic between all combination of nodes A-F (e.g. all nodes A-F must be able to send/receive data to/from each other of nodes A-F) and the constraint is that the network topology has to be protected (e.g. there must be at least two different paths between each of nodes A-F) then the systems and methods described herein may identify the network topology 200 shown in FIG. 2 as the optimized version of the topology 100 shown in FIG. 1. If however, there is no constraint that the network is to be protected then the systems and methods described herein may identify the network topology 300 shown in FIG. 3 as the optimized version of the topology 100 shown in FIG. 1. In the network topology of FIG. 3 each of nodes A-F has a path or route to each of the other nodes A-F, but there is no redundancy.

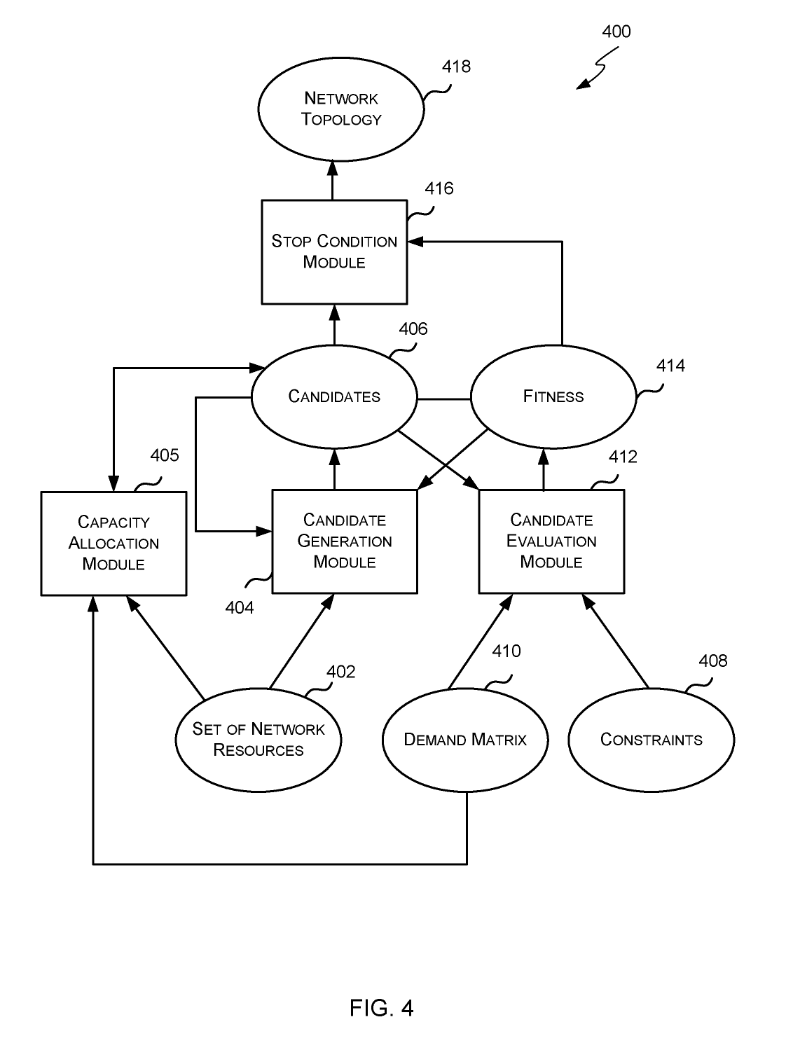

Reference is now made to FIG. 4 which illustrates an example system 400 for identifying an optimum network topology for a set of service requirements based on one or more constraints. The system 400 uses an iterative process to refine and evaluate network topology candidates to identify the optimum network topology.

The system 400 comprises a candidate generation module 404 for generating and iteratively evolving a set of candidate network topologies 406; a capacity allocation module 405 for assigning capacity values to the links of the candidate network topologies 406; a candidate evaluation module 412 for evaluating the candidate network topologies 406 to determine how well they meet the services requirements 410 and one or more constraints 408; and a stop condition module 416 for determining, based on the evaluation of the candidate network topologies, when the iterative process can be stopped and then selecting the best candidate network topology as the optimum network topology 418.

The candidate generation module 404 receives a set of network resources 402 and generates a set of candidate network topologies 406.

The set of network resources 402 comprises all of the components that may form the network and the possible configurations thereof. For example, the set of network resources 402 may comprise all of the possible nodes in the network, all of the potential links in the network, all of the possible capacity options for each link in the network, and/or all of the possible hardware components that can be used to form the network. The set of network resources may be generated by the user/owner of the network based on the options available to them to create their network. For example, the nodes may represent datacenters and the links between them may be the full list of options they have for linking two (or more) datacenters together. Such options may include, microwave links, satellite links, laying fiber, renting fiber, or renting capacity on a third party's fiber/microwave/satellite links.

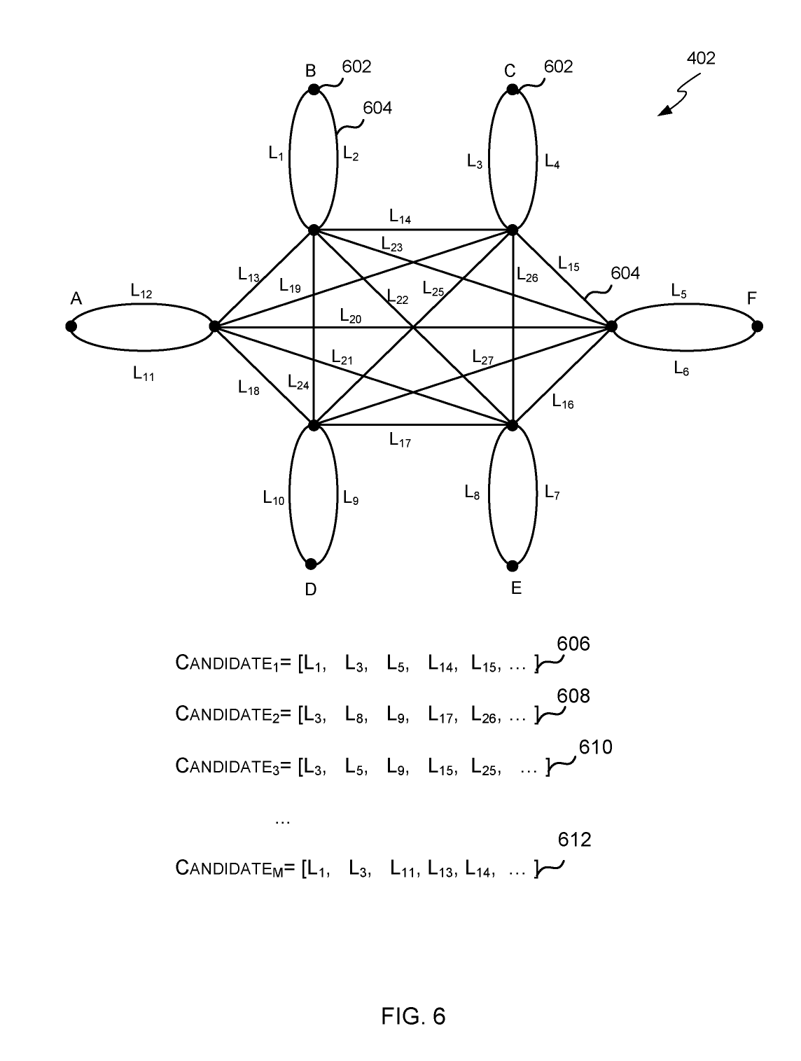

The candidate generation module 404 takes the set of network resources 402 and generates and periodically updates a set of candidate network topologies 406. Each candidate network topology represents a set of nodes and links from the set of network resources 402 that form a network topology. Example candidate network topologies are described with reference to FIG. 6.

In the first iteration the candidate generation module 404 is configured to generate a predetermined number, in one example 50, of candidate network topologies from the set of network resources 402 to form the set of candidate topologies 406. The predetermined number of candidate network topologies may be an arbitrary number based on the available memory.

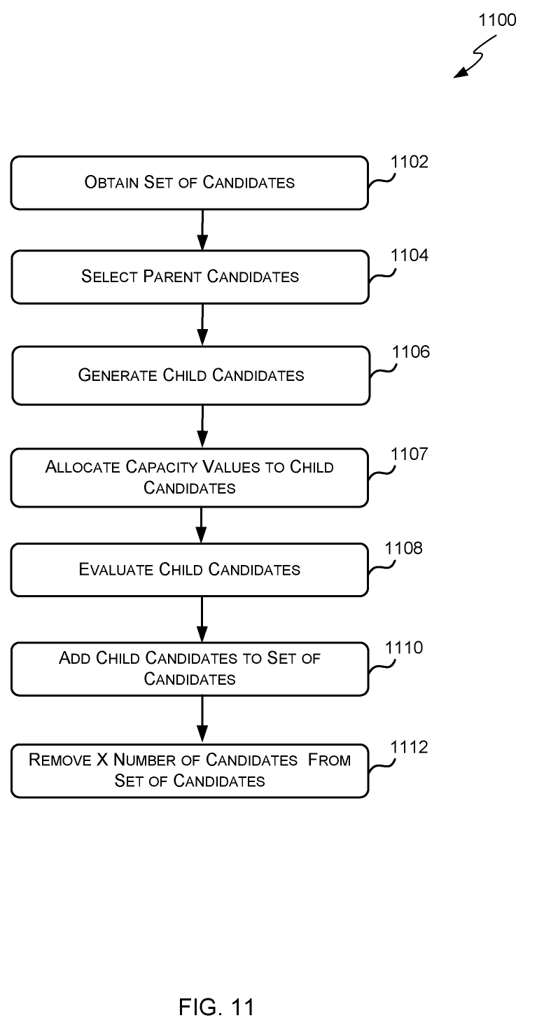

In subsequent iterations, the candidate generation module 404 is configured to update or evolve the set of candidate network topologies 406 by selecting one or more candidate network topologies from the set of candidate network topologies, forming new candidates from the selected candidates (e.g. via mutation, mating (e.g. crossover) and/or a combination thereof), and replacing some of the candidate network topologies with the new candidate network topologies. In some cases the new candidate network topologies replace the poorest candidate network topologies in the set if they are better. In other cases, the candidate network topologies that are replaced by the new candidate network topologies may be selected using other criteria. For example, the candidate network topologies that are replaced by the new candidate network topologies may be randomly selected from the set of candidate network topologies. An example method for updating or evolving the set of candidate network topologies 406 that may be executed by the candidate generation module 404 is described with reference to FIG. 11.

The capacity allocation module 405 assigns a capacity (e.g. bandwidth) value to each link of the candidate network topologies 406. In some cases assigning capacity (e.g. bandwidth) values to the links of a candidate network topology comprises determining the best route for each service through the candidate network topology. The best route for a service comprises a set of links that the traffic traverses to get from the start node to the end node. The best route for each service may be determined by a generic routing engine (GRE) through an iterative process. The iterative process may comprise generating a set of candidate service routings, evaluating the candidate service routings to determine how well they satisfy the routing constraints specified in the demand matrix and/or requirements for each service and evolving the set of candidate service routings until a stop condition has been met. Alternatively, the services may be routed using a known routing protocol such a Border Gateway Protocol (BGP), Internet Protocol (IP), IP with equal-cost multi-path (ECMP), least cost, or constrained shortest path first (CSPF).

Once the routing of services has been determined the utilization of each link is determined. A capacity (e.g. bandwidth) value is then assigned to each link to satisfy the utilization. For example, if the utilization of a link is 10 Gbps, then a capacity (e.g. bandwidth) value of at least a bandwidth of 10 Gbps would be assigned to the link.

In some cases the capacity allocation module 405 may also take into account maximum utilization values that have been assigned to one or more of the links when assigning capacity (e.g. bandwidth) values. For example, if a particular link has been assigned a maximum utilization of 33% then a calculated utilization of 10 Gbps would result in a capacity value of at least 30 Gbps being assigned to the link.

In some cases the best route for the services is determined for the candidate network topology in steady-state (e.g. all nodes and links are active). In other cases the best route for the services is also determined for the candidate topology in one or more failure states (e.g. under one or more failure conditions). A failure condition may be one or more network failures, such as failure of a link, node, shared risk group etc., during which services unaffected by the failure are not re-routed and services affected by the failure are only re-routed if they are protected.

In cases where the best route for the services is determined for the candidate network topology in steady state and in one or more failure states a bandwidth value is assigned to each link to satisfy the maximum utilization of that link in both steady state and the one one or more failure states. For example, if the utilization of a link is 10 Gbps in steady state, and 25 Gbps in a failure state then a capacity value of at least 25 Gbps is assigned to the link for that demand/growth scenario.

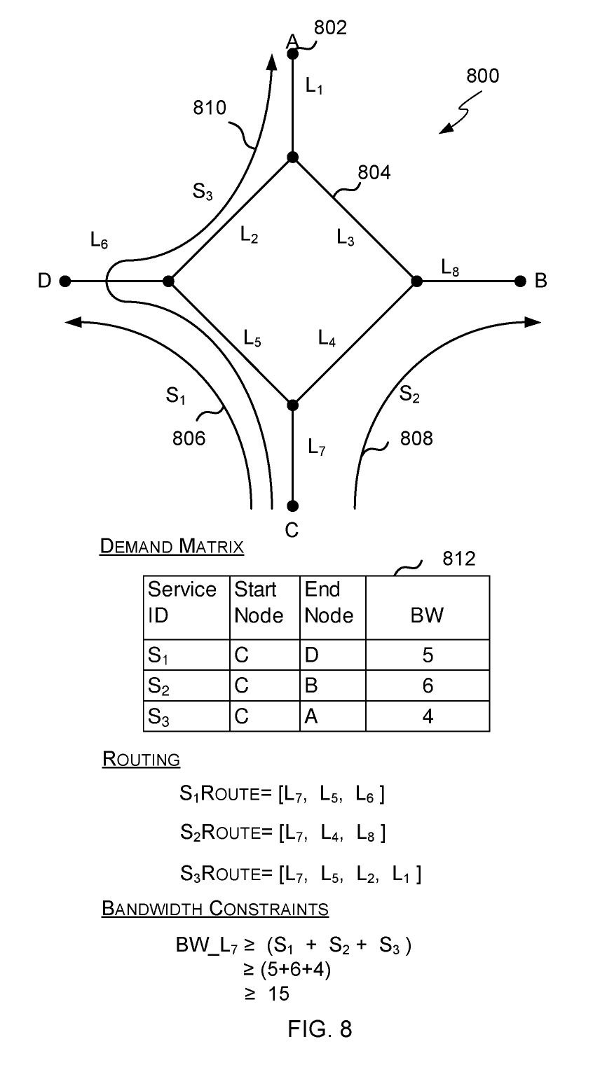

An example method for assigning capacity (e.g. bandwidth) values to a candidate network topology is described with reference to FIG. 8.

The candidate evaluation module 412 evaluates each of the candidate network topologies (including the service routing and capacity values identified by the capacity allocation module 405) 406 based on how well the candidate network topology satisfies a set of constraints 408 and service demands set out in a demand matrix 410.

The set of constraints 408 includes a list of features (referred to as a constraint) that the candidate network topologies are evaluated against. The set of constraints may be determined by the user/owner of the network based on the way in which they wish to optimize their network topology. For example, one user may wish to generate the cheapest (in monetary terms) network that can support their demands; another user may wish to generate the topology that provides the lowest latency regardless of the monetary cost; and yet another user may wish to achieve the best latency for a given cost.

The constraints may be classified as being either hard constraints or soft constraints. A hard constraint must be satisfied for the candidate network topology to be a viable solution. Accordingly a candidate network topology that does not satisfy a hard constraint will have a low fitness value (as described in more detail below). Example hard constraints include, but are not limited to, minimum bandwidth, maximum delay, and adjacency limit. In contrast, a soft constraint is preferred and ideally should be optimized, but is not required. Example soft constraints include, but are not limited to, minimize cost and minimize delay.

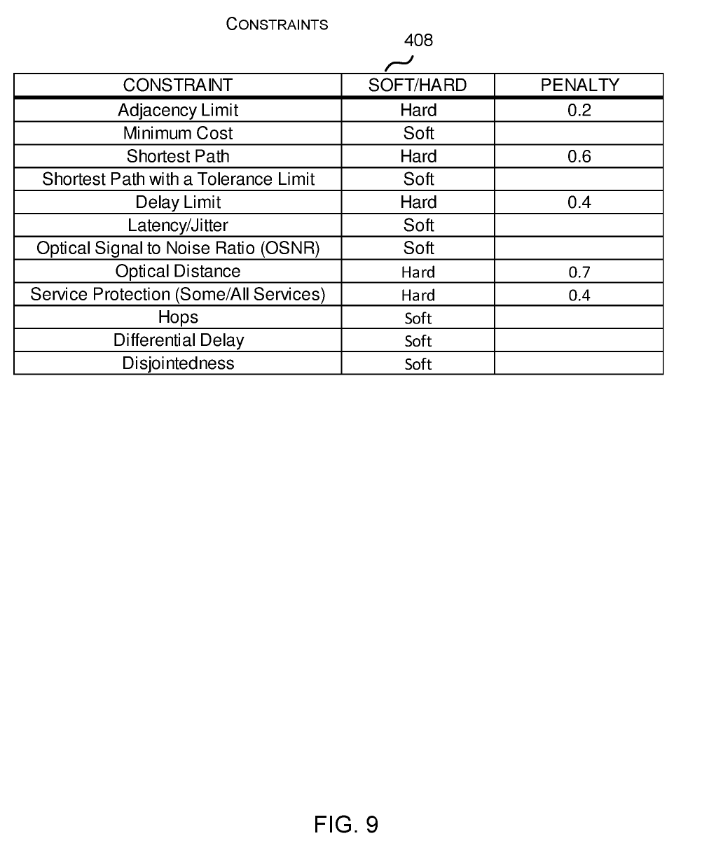

Not all constraints may be of equal importance, so in some cases the set of constraints 408 may comprise, in addition to a listing of the constraints themselves, weights indicating the relative importance of the constraints. Constraints will be described in more detail with reference to FIG. 9.

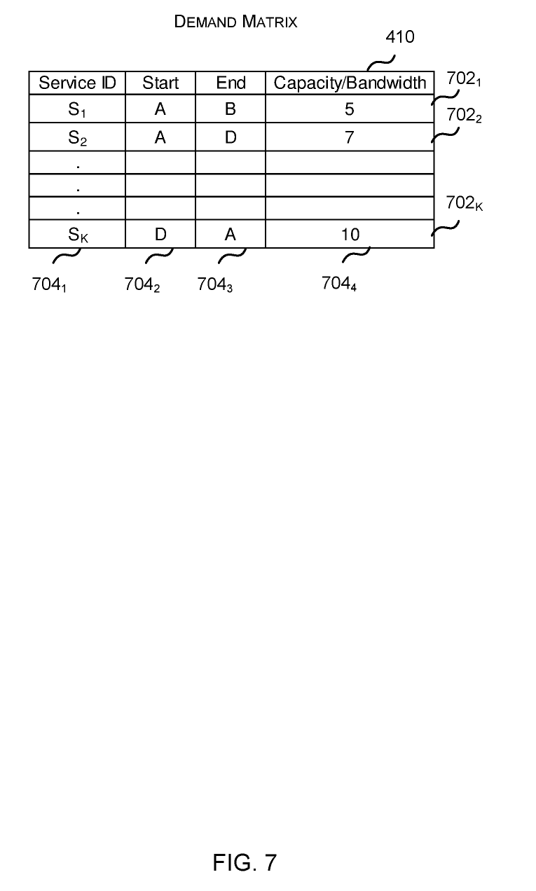

The demand matrix 410 provides a list of services to be routed through the network and the requirements of the service. As described above a service represents traffic that is sent from one node (e.g. the start or source node) in the network to another (e.g. the end or destination node). The requirement or demand of a service is the amount of traffic sent from the start node to the end node. An example demand matrix 410 is described with reference to FIG. 7.

In some cases the candidate evaluation module 412 is configured to generate a fitness value 414 for each candidate network topology where each fitness value provides a quantitative measure of how well the candidate network topology (including the routing of services and capacity values identified by the capacity allocation module 405) meets the constraints and service requirements. In some cases the fitness value is a number between 0 and 1 where 1 indicates an optimum candidate and 0 indicates a very poor candidate.

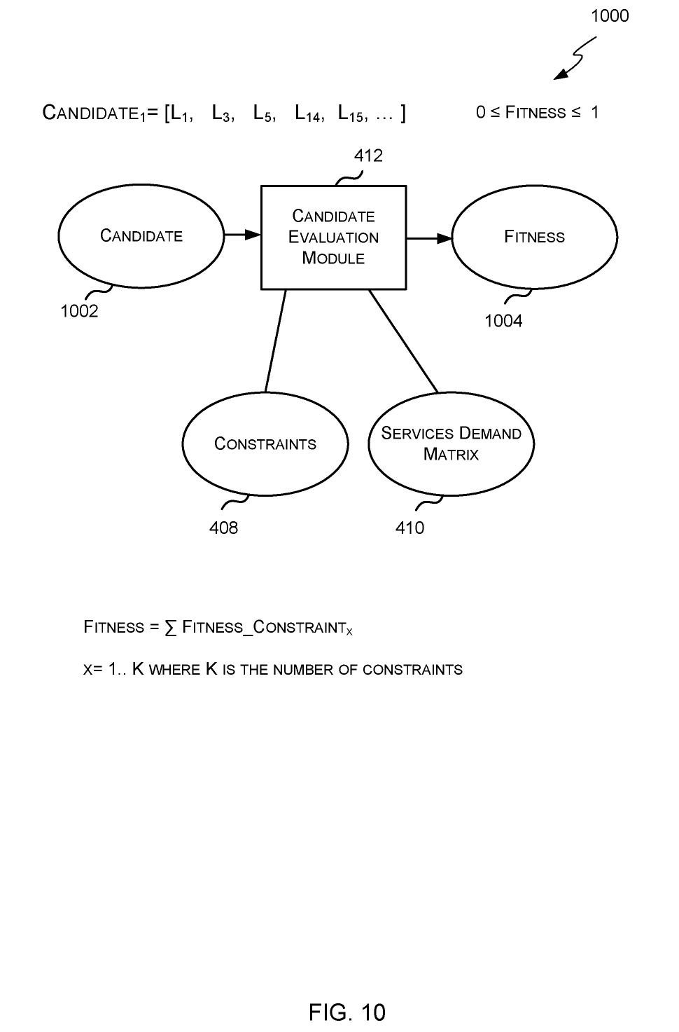

In some cases the fitness value may be generated by computing a sub-fitness value for each constraint/service requirement from a specific fitness function; and combining (e.g. summing or averaging) the sub-fitness values. In some cases all constraints may not be of equal importance so the final value may be a weighted combination (e.g. sum or average) of sub-fitness values where the weights assigned to different sub-fitness values indicate the relative importance of their corresponding constraint. An example method for generating a fitness value for a candidate network topology is described with reference to FIG. 10.

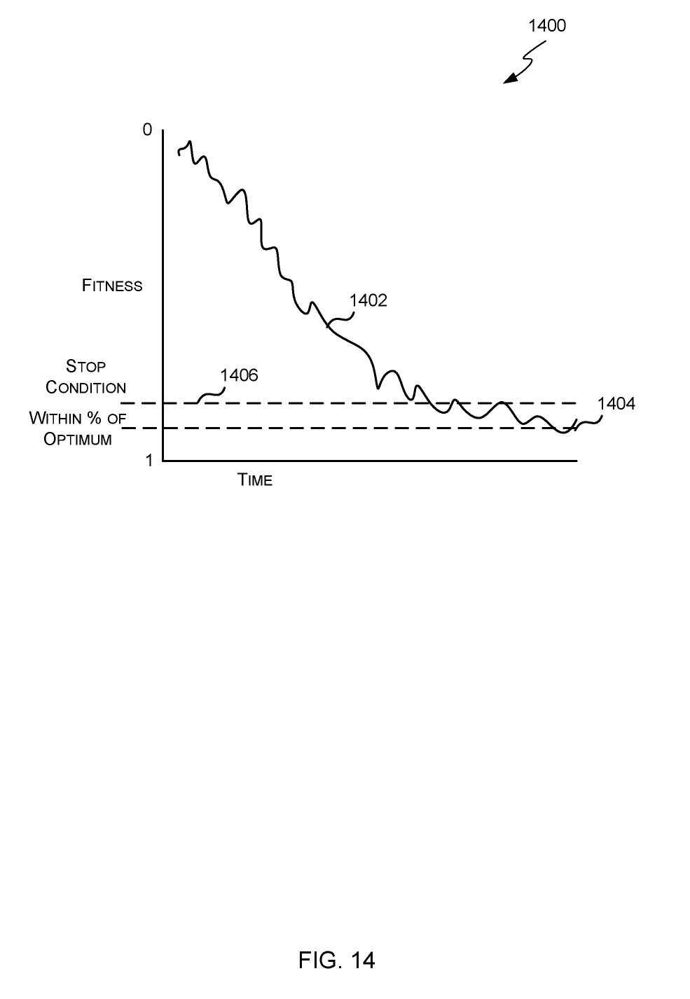

The stop condition module 416 determines when the iterative process of evaluating and updating/evolving the candidate network topologies 406 can end. In particular, the stop condition module 416 determines that the iterative process can stop if at least one stop condition has been met. One or more stop conditions may indicate that a sufficiently optimum network topology has been identified For example, the stop conditions may comprise one or more of: if the best fitness value in the set of fitness values 414 is within a predetermined percentage, Q, of the predicted optimum fitness value; if the best fitness value in the set of fitness values has not improved or changed after a predetermined number, R, of iterations; or if the best fitness value has a percentage likelihood of being the optimum fitness value over a predetermined threshold. An example stop condition will be described with reference to FIG. 14.

If the stop condition module 416 determines that at least one stop condition is met the stop condition module 416 selects the candidate network topology or topologies that has/have the best fitness value and outputs the selected candidate network topology/topologies as the optimum network topology 418.

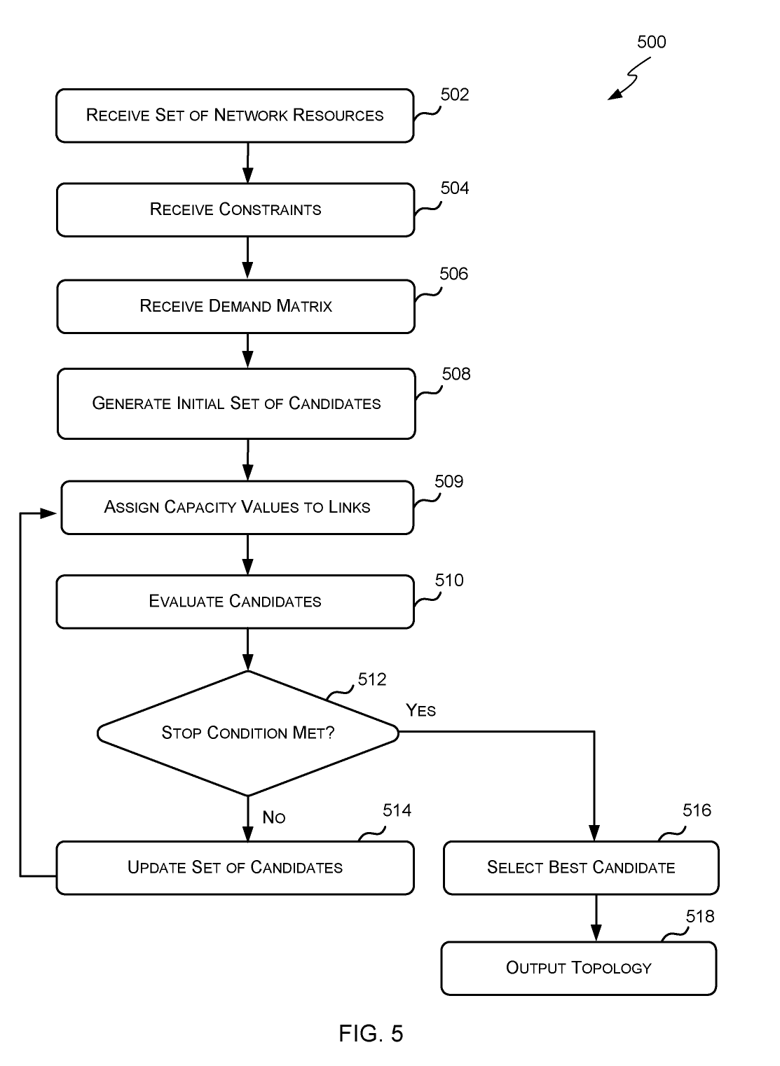

Reference is now made to FIG. 5 which illustrates a method 500 for identifying an optimum network topology to satisfy a set of service requirements under one or more constraints using the system 400 of FIG. 4. The method identifies an optimum network topology through an iterative process that generates a set of candidate network topologies, evaluates the candidate network topologies, and evolves or updates the set of candidate network topologies to create a set of stronger candidate network topologies. Since the quality of the candidate network topologies increases after each iteration, each iteration increases the probability that the set of candidate network topologies comprises the optimum network topology.

The method 500 begins at block 502 where the candidate generation module 404 receives the set of network resources 402. As described above, the set of network resources 402 comprises all of the potential components of the network and the possible configurations thereof which can be used to build the network topology. For example, the set of network resources 402 may comprise, for example, all of the possible nodes in the network, all of the potential links in the network, all of the possible capacity options for each link in the network, all of the possible hardware components that can be used to form the network etc. Once the set of network resources 402 have been received the method 500 proceeds to block 504.

At block 504, the candidate evaluation module 412 receives the set of constraints 408. As described above, the set of constraints 408 specify the features of the network topology that are used to evaluate the quality of a candidate network topology. The set of constraints may comprise one or more hard constraints which must be met for a candidate network topology to be viable and/or one or more soft constraints which are to be optimized, but are not required. The constraints may not be of equal importance and thus each constraint may be associated with a weight value that indicates its relative importance with respect to the other constraints. Once the set of constraints have been received the method 500 proceeds to block 506.

At block 506, the candidate evaluation module 412 receives the demand matrix 410. As described above, the demand matrix 410 provides a list of services to be routed through the network and the requirements of each service. As described above a service represents traffic that is sent from one node (e.g. the start or source node) in a network to another (e.g. the end or destination node). The requirement/demand of a service is the amount of traffic that is sent from the start node to the end node. Each service may also be associated with one or more routing rules/constraints that explain how the service should be routed through the network. These may be treated as a feature of the service or may be treated as a constraint. Once the demand matrix 410 has been received the method 500 proceeds to block 508.

It will be evident to a person of skill in the art that blocks 502 to 506 may be executed in any order or in parallel. For example, the system 400 may concurrently receive the set of network resources 402, the demand matrix 410 and the set of constraints 408.

At block 508, the candidate generation module 404 generates an initial set of M (e.g. 50) candidate network topologies 406 from the set of network resources 402. Each candidate network topology comprises a subset of the nodes and links of the set of network resources 402. In some cases each candidate network topology is represented by a vector of links. The term “vector” is used herein to mean an ordered or unordered list of elements. An example set of candidate network topologies is described with reference to FIG. 6.

As described above the candidate generation module 404 may be configured to randomly generate the candidate network topologies from the set of network resources 402. Randomly generating a candidate network topology may comprise randomly selecting some or all of the links in the set of network resources 402.

Once the initial set of candidate network topologies has been generated the method 500 proceeds to block 509.

At block 509, the capacity allocation module 405 assigns a capacity (e.g. bandwidth) value to each link of the candidate network topologies. As described above with reference to FIG. 4, assigning capacity (e.g. bandwidth) values to the links of a candidate network topology may comprise determining the best route for each service through the candidate network topology.

The best route for a service comprises a set of links that the traffic traverses to get from the start node to the end node. The best route for each service may be determined by a generic routing engine (GRE) through an iterative process. The iterative process may comprise generating a set of candidate service routings; evaluating the candidate service routings to determine how well they satisfy the routing constraints specified in the demand matrix 410 and/or requirements for each service; and evolving the set of candidate service routings until a stop condition has been met. Alternatively, the routing of the services may be determined using a known routing protocol such a Border Gateway Protocol (BGP), Internet Protocol (IP), IP with equal-cost multi-path (ECMP), least cost, or constrained shortest path first (CSPF).

Once the routing of the services through the candidate network topology has been determined the utilization of each link is then determined from the requirements in the demand matrix 410. A bandwidth is then assigned to each link to satisfy the utilization. For example, if the utilization of a link is 10 Gbps, a capacity (e.g. bandwidth) value of at least 10 Gbps would be assigned to the link.

The actual capacity (e.g. bandwidth) value assigned may be based on the information in the set of network resources 402. In particular, the set of network resources 402 may specify the incremental increases in capacity that can be made for any particular link. For example, the set of network resources 402 may specify that a particular link may only be increased by 10 Gbps or 100 Gbps increments. The set of network resources 418 may also specify a maximum utilization value for one or more of the links. For example, if a particular link is assigned a maximum utilization of 33.33% then a calculated utilization of 10 Gbps results in a capacity value of at least 30 Gbps being assigned to the link.

In some cases the best route for the services is determined for the candidate network topology in steady-state (e.g. all nodes and links are active). In other cases the best route for the services is also determined for the topology in one or more failure states (e.g. under one or more failure conditions). A failure condition may be one or more network failures, such as failure of a link, node, shared risk group etc., during which services unaffected by the failure are not re-routed and services affected by the failure are only re-routed if they are protected.

Where the best route is determined for both steady state and one or more failure states the minimum bandwidth for a link is based on the maximum utilization of the link in steady state and the one or more failure states. For example, if the utilization of a link in steady state is 20 Gbps and the utilization of the link in a failure state is 35 Gbps then the capacity (e.g. bandwidth) value assigned to the link must be at least 35 Gbps.

Once capacity (e.g. bandwidth) values have been assigned to the links of the candidate network topologies, the method 500 proceeds to block 510.

At block 510, the candidate evaluation module 412 evaluates each candidate network topology (including the services routing and capacity values identified in block 509) against the set of constraints 408 and the service requirements specified by the demand matrix 410. In some cases evaluation of a candidate network topology comprises assigning the candidate network topology a fitness value 414 that is a quantitative measure of how well the candidate network topology meets the set of constraints 408 and the service requirements specified by the demand matrix 410.

As described above, in some cases generating a fitness value may comprise determining a sub-fitness value for each constraint/service requirement where the sub-fitness value is a quantitative measure of how well the candidate network topology meets the specific constraint/service requirement and combining (e.g. summing or averaging) the sub-fitness values to generate the fitness value. An example method for generating a fitness value is described with reference to FIG. 10.

The candidate network topologies may be evaluated (e.g. assigned a fitness value) serially (e.g. one at a time) or in parallel. For example, in some cases the candidate network topologies are evaluated in parallel.

Once the set of candidate network topologies 406 have been evaluated, the method 500 proceeds to block 512.

At block 512 the stop condition module 416 determines whether at least one stop condition has been met. The stop condition(s) may be, for example, if the best fitness value in the set of fitness values 414 is within a predetermined percentage, Q, of the predicted optimum fitness value; if the best fitness value in the set of fitness values has not improved or changed after a predetermined number, R, of iterations; and/or the likelihood that the best fitness value in the set of fitness values is above a predetermined threshold. It will be evident to a person of skill in the art that these are examples only and other stop conditions may be used.

If the stop condition module 416 determines that none of the stop conditions have been met then the method 500 proceeds to block 514. If, however, the stop condition module 416 determines that at least one stop condition has been met then the method 500 proceeds to block 516.

At block 514, the candidate generation module 404 updates or evolves the set of candidate network topologies in an attempt to increase the quality of the candidate network topologies in the set. In particular, it is very unlikely that the initial set of candidate network topologies comprises the optimum network topology therefore the set of candidates is evolved to pull the candidate network topologies closer to the optimum network topology.

In some cases evolving the set of candidate network topologies comprises selecting one or more of the candidate network topologies from the set of candidate network topologies, generating one or more new candidate network topologies from the selected candidate network topologies and replacing some of the candidate network topologies in the set with the new candidate network topologies. In some cases the new candidate network topologies only replace candidate network topologies in the set if the new candidate network topologies are better (e.g. based on a fitness value) than candidate network topologies in the set. In other cases the worst candidate (e.g. based on fitness values) is retained in the set of candidate network topologies to preserve diversity. Deciding to retain the worse candidate network topology is driven by a probability determined by the fitness of the candidate.

For example, in some cases the candidate generation module 404 is configured to select two or more parent candidate network topologies from the set of candidate network topologies. The parent candidate network topologies may be the candidates with the best fitness values or the parent candidate network topologies may be selected in another manner (e.g. they may be randomly selected). The candidate generation module 404 then generates one or more child candidate network topologies from the parent candidate network topologies using known techniques such as mating, mutation, or a combination thereof. The candidate generation module 404 then adds the child candidate network topologies to the set of candidate network topologies. An example method for updating or evolving the set of candidate network topologies is described with reference to FIGS. 11 to 13.

The method 500 then proceeds back to blocks 509 and 510 where the capacity allocation module 405 allocates capacity values to the links of the candidate child network topologies and the candidate evaluation module 412 evaluates (e.g. assigns a fitness value to) each of the child candidate network topologies. The candidate evaluation module 412 then updates the set of candidate network topologies to include M candidate network topologies where M is the number of candidate network topologies initially generated in block 508. In some cases the best M candidate network topologies (e.g. based on the fitness values) are selected. In other cases M candidate network topologies are randomly selected. This process of evolving the set of the candidate network topologies is repeated until a stop condition is satisfied in block 512.

At block 516, once a stop condition has been met, the stop condition module 416 selects the best candidate network topology (e.g. the candidate network topology with the best fitness value). Once the best candidate network topology has been selected the method 500 proceeds to block 518. At block 518 the selected/best candidate network topology and the capacity (e.g. bandwidth) values assigned thereto are output as the optimum network topology for the service requirements specified in the demand matrix and the constraint(s).

Reference is now made to FIG. 6 which illustrates a method for generating candidate network topologies based on a set of network resources 402. In particular FIG. 6 shows an example of the nodes 602 and links 604 that form a set of network resources 402. Each link 604 is assigned a label or identifier (L₁ . . . L₂₇) which identifies the link—e.g. identifies which two nodes it connects.

A candidate network topology is any combination of the links 604 in the set of network resources 402. Accordingly, a candidate network topology may comprise all or a subset of the links 604 in the set of the network resources 402. The combination of links may be represented by an array or vector. In one example, as shown in FIG. 6, the array or vector may comprise a list of link identifiers. In this example, the order of the links is not relevant since it is the identifier that identifies the link. In another example, the array or vector may comprise a bit for each possible link and when that link has been selected as part of the candidate the bit is set, otherwise the bit is cleared. In this example, the order of the information in the array or vector is relevant as certain bits map back to certain links.

The candidate generation module 404 may be configured to generate the initiate set of M candidate network topologies 606, 608, 610, 612 by randomly selecting a number of links of the set of possible links and saving the selected link identifiers in an array or vector. The candidate network topologies do not have to have the same number of links and in fact they are likely to have different numbers of links. For example, FIG. 6 illustrates several candidate network topologies 606, 608, 610, 612 that may be generated from the set of network resources 402 illustrated in FIG. 6. The first example candidate network topology 606 comprises links L₁, L₃, L₅, L₁₄ and L₁₅; the second example candidate network topology 608 comprises links L₃, L₈, L₉, L₁₇ and L₂₆; the third example candidate network topology 610 comprises links L₃, L₅, L₉, L₁₆, and L₂₆; and the M^{th} example candidate network topology 612 comprises links L₁, L₃, L₁₁, L₁₃ and L₁₄.

Reference is now made to FIG. 7 which illustrates an example demand matrix 410. As described above the demand matrix 410 provides a list of services to be routed through the network and the requirements of the services. As described above a service represents traffic that is sent from one node (e.g. the start or source node) in a network to another (e.g. the end or destination node). The requirement or demand of a service is the amount of traffic that is sent from the start node to the end node.

The demand matrix 410 of FIG. 7 comprises a number of rows 702₁-702_{K} and columns 704₁-704₄.

Each row 702₁-702_{K} corresponds to a service that runs over the network. Accordingly, where there are K services there are K rows in the demand matrix 410. In some cases each possible combination of start and end nodes in the network is represented by a service. For example, where a network has four possible start/end nodes (A, B, C and D) there are 4*3=12 possible combinations of start and end nodes thus the demand matrix would have twelve rows.

Each column 704₁-704₄ provides information on the corresponding service. In the demand matrix 410 of FIG. 7, the first column 704₁ is used for the service identifier (e.g. S₁) which uniquely identifies the service. The second column 704₂ is used to identify the start node of the service, and the third column 704₃ is used to identify the end node of the service. In some cases nodes may be assigned a unique identifier which is used to identify the start and end nodes in the demand matrix 410. In the example shown in FIG. 7 each node is assigned a letter, but it will be evident to a person of skill in the art that this is an example only and other forms of unique identifiers may be used.

The fourth column 704₄ identifies the demand or requirement for the service (e.g. the amount of traffic that is sent from the specified start node to the specified end node). Each requirement may be represented, for example, by a capacity or bandwidth value (e.g. 10 Gbps).

It will be evident to a person of skill in the art that the demand matrix 410 of FIG. 7 is an example only and the demand matrix may comprise additional or alterative information; or the services and the requirements thereof may be represented in a different manner. For example, the demand matrix 410 may also specify other constraints that are specific to the service, such as, but not limited to the class of service and whether the service is to be protected. As described above a protected service is one that requires a backup route between the start and end nodes to enable the service to be run in the event the primary route fails.

Reference is now made to FIG. 8 which illustrates assigning capacity (e.g. bandwidth) values to a candidate network topology 800. In FIG. 8 the candidate network topology 800 comprises eight nodes 802 (including four edge nodes A, B, C and D) and eight links (L₁-L₈) 804 connecting the nodes. There are three services S₁ 806, S₂ 808 and S₃ 810 running over the network. The first service S₁ 806 sends traffic from node C to node D, the second service S₂ 808 sends traffic from node C to node B, and the third service S₃ 810 sends traffic from node C to node A. The requirement of each service is set out in a demand matrix 812.

To allocate capacity (e.g. bandwidth) values to each link 804 of the candidate network topology 800, first the best route (the set of links traversed to get from the start node to the end node) for each service is determined using, for example, a generic routing engine (GRE) or a known routing protocol as described above.

In the example of FIG. 8, it is determined that the first service S₁ 806 is routed from node C to node D via L₇, L₅ and L₆; the second service S₂ 808 is routed from node C to node B via L₇, L₄, and L₈; and the third service S₃ 810 is routed from node C to node A via L₇, L₅, L₂ and L₁.

Next it is determined, for each link, the amount of traffic that will run over that link (i.e. the utilization of the link). In particular, the utilization of a link will be equal to the sum of the requirements for each service that runs over the link. For example, all three services S₁, S₂ and S₃ run over L₇ thus the amount of traffic run over L₁ is 15 (5+6+4).

Once the utilization of a link has been determined, a capacity (e.g. bandwidth) value greater than or equal to the utilization is assigned to that link. For example, the utilization for L₇ is 15, thus a capacity (e.g. bandwidth) value of at least 15 is assigned to L₇.

In some cases maximum utilization values are assigned to one or more of the links which may be taken into account in assigning capacity (e.g. bandwidth) values to the links. For example, if a particular link is assigned a maximum utilization of 33.33% then a calculated utilization of 10 Gbps would result in a capacity value of at least 30 Gbps being assigned to the link. The maximum utilization values may be set out in the set of network resources 402.

The actual capacity (e.g. bandwidth) values that can be assigned to a particular link may be set out in the set of network resources. For example, the set of network resources 402 may specify that the bandwidth on a certain link may only be increased in increments of 10 Gbps or 100 Gbps.

In some cases the best route for each service is determined for the candidate network topology both in steady state (e.g. all links and nodes are active) and in one or more failure states (e.g. one or more nodes and/or links is deemed inactive). In these cases the amount of traffic over each link in each state is then determined. A capacity (e.g. bandwidth) value is assigned to each link to satisfy the maximum traffic or utilization over all states.

Reference is now made to FIG. 9 which illustrates an example set of constraints 408. As described above the constraints outline the metrics for evaluating the candidate network topologies. For example, the constraints 408 of FIG. 9 include the following: adjacency limit; minimum cost; shortest path; shortest path with tolerance; delay limit; latency/jitter; optical signal to noise ratio (OSNR); optical distance; service protection; hops; differential delay; and disjointedness.

An adjacency limit constraint specifies that the number of adjacent nodes is to be limited. This limit may be required due to a hardware limit (e.g. maximum number of cards) etc. A minimum cost constraint specifies that the minimum routed cost solution should be selected. A shortest (distance) path constraint specifies that the shorted distance path/route should be selecting when routing services. The user may be able to specify an acceptable tolerance limit so that the absolute shortest path/route does not always have to be taken, but a route that is within the tolerance of being the shortest path is acceptable. The delay limit constraint specifies the maximum amount of delay between transmission and receipt of service traffic. The latency/jitter constraint specifies that latency or jitter should be minimized.

The OSNR constraint specifies that OSNR should be optimized. The optical distance specifies that the maximum distance for optical links cannot be exceeded (otherwise the optical link will not work or needs to be regenerated incurring additional expense and network complexity). The service protection constraint specifies that there should be a backup route available in case the main route has a failure. This constraint can be specified for all or only some of the services. The hops constraint specifies that the number of hops between start and end nodes should be minimized. The differential delay constraint specifies that the difference in delay between two or more services should be minimized. The disjointedness constraint specifies that there should be no shared links, nodes and/or shared risk groups (SRGs) between one or more disjoint services.

The constraints may be classified as being either hard constraints or soft constraints. A hard constraint must be satisfied for the candidate network topology to be a viable solution. Accordingly a candidate network topology that does not satisfy a hard constraint will have a poor fitness value (as described in more detail below). Hard constraints usually specify a particular threshold that has to be met. In the example set of constraints in FIG. 9, the adjacency limit, shortest path limit (without tolerance), delay limit, optical distance and service protection constraints are hard constraints. All the other constraints are soft constraints.

The hard constraints may be assigned a penalty value which is used in calculating the fitness value for when the constraint is not met. This is used to push the fitness value to a poorer or less favorable value when a candidate network topology does not meet a hard constraint.

It will be evident to a person of skill in the art that the constraints illustrated in FIG. 9 are examples only and any other routing, topology or other type of constraints may be used or specified.

Reference is now made to FIG. 10 which illustrates an example method 1000 for evaluating a candidate network topology (including the service routings and capacity values identified by the capacity allocation module 405) 1002 which may be executed by the candidate evaluation module 412. In particular, in the example method 1000 the candidate evaluation module 412 may be configured to evaluate a candidate network topology 1002 by generating a fitness value 1004 for the candidate network topology 1002 where the fitness value 1004 is a quantitative measure of how well the candidate network topology (including the service routings and capacity values identified by the capacity allocation module 405) 1002 meets the specified constraints 408 and service requirements as specified by the demand matrix 410. In other words the fitness value 1004 defines how “good” a candidate network topology is and thus can be used to rank candidate network topologies.

The fitness value 1004 may be a number between 0 and 1 where 1 indicates the best network topology and 0 indicates a poor network topology (or vice versa). However, it will be evident to a person of skill in the art that this is an example only and that the fitness value 1004 may be generated to fall in a different range.

In some cases the fitness value 1004 may be generated by calculating a sub-fitness value for each constraint/service requirement and determining the average of the sub-fitness values. For example, the fitness value 1004 may be calculated using equation (1) shown below:

$$FitnessValue = {\sum }_{x = 1}^{k} ( \frac{{SubFitnessValue}_{x}}{k} ) \qquad ( 1 )$$

where k is the number of constraints/service requirements.

As described above, not all constraints may be of equal importance and so in some cases the fitness value 1004 may be calculated from a weighted average of the sub-fitness values (the fitness values for each constraint/service requirement) where the weights are assigned based on the relative importance of the corresponding constraint. For example, the sub-fitness value may be calculated using equation (2) shown below:

$$FitnessValue = {\sum }_{x = 1}^{k} ( \frac{{SubFitnessValue}_{x} * {Weight}_{x}}{k} ) \qquad ( 2 )$$

where k is the number of constraints/service requirements, and Weight, is the weight assigned to the x^{th} constraint.

Each sub-fitness value may be generated from a corresponding fitness function that assesses how well the network topology meets the corresponding constraint/service requirements. Where the constraint is a hard constraint (e.g. a specific upper or lower limit is specified for the constraint) and the candidate network topology 1002 does not meet the constraint, then a penalty may be assessed against the sub-fitness value. For example, the fitness value may be adjusted based on the penalty value according to formula (3) shown below:

SubFitnessValue=SubFitnessValue*(PenaltyNumber of Failures) (3)

where Penalty is a value between 0 and 1 and Number of Failures is the number of times the candidate network topology failed to meet the constraint. For example, if the hard constraint was a maximum number of adjacencies then each time the candidate network topology exceeded the maximum number of adjacencies then the Number of Failures is increased.

Each sub-fitness value (a value indicating the fitness for particular constraint) may be calculated in accordance with a fitness function. Accordingly, if the constraints comprise a cost constraint, a utilization constraint, delay constraint, speed constraint, efficiency constraint, and a disjointed constraint then there may be corresponding cost, utilization, delay, speed, efficiency and disjointed fitness functions.

A disjointed fitness function determines whether the routes through the candidate network topology for disjointed services share any links and/or nodes. The disjointed fitness function may be configured so that any sharing of links and/or nodes between the routes of disjointed services results in a decrease in the fitness value for the candidate network topology. A cost fitness function may compute the sum of the costs of a network topology and compare this to a provided cost budget.

Reference is now made to FIG. 11 which illustrates an example method 1100 for evolving the set of candidate network topologies which may be executed by the candidate generation module 404, the capacity allocation module 405 and the candidate evaluation module 412. The objective of the evolving is to increase the quality of the candidate network topologies in the set.

The example method 1100 of FIG. 11 comprises identifying one or more parent candidate network topologies in the set of candidate network topologies, generating child candidate network topologies from the parent candidate network topologies, evaluating the child candidate network topologies, adding the child network topologies to the set of candidate network topologies and selecting M candidate network topologies from the combined set to continue. In some cases, the best M candidate network topologies (e.g. based on the fitness values) are selected. In other cases M candidate network topologies are selected randomly, and in yet other cases the best N candidate network topologies are selected (e.g. based on the fitness values) and M-N random candidate network topologies are selected.

The method 1100 starts at block 1102 where the candidate generation module 404 obtains the current set of candidate network topologies 406. Once the current set of candidate network topologies 406 has been obtained, the method 1100 proceeds to block 1104.

At block 1104, the candidate generation module 404 selects a predetermined number, in one example 2, of parent candidate network topologies from the set of candidate network topologies 406. The parent candidate network topologies may, for example, be selected based on their associated fitness value (e.g. the best candidate network topologies based on their fitness values may be selected as the parents) or they may be selected using other criteria (e.g. the parent candidate network topologies may be randomly selected or they may be selected based on a weighted random method). It will be evident to a person of skill in the art that there are many methods and/or criteria that can be used to select the parent candidate network topologies Once the parent candidate network topologies have been selected the method 1100 proceeds to block 1106.

At block 1106, the candidate generation module 404 generates one or more child candidate network topologies from the parent candidate network topologies selected in block 1104.

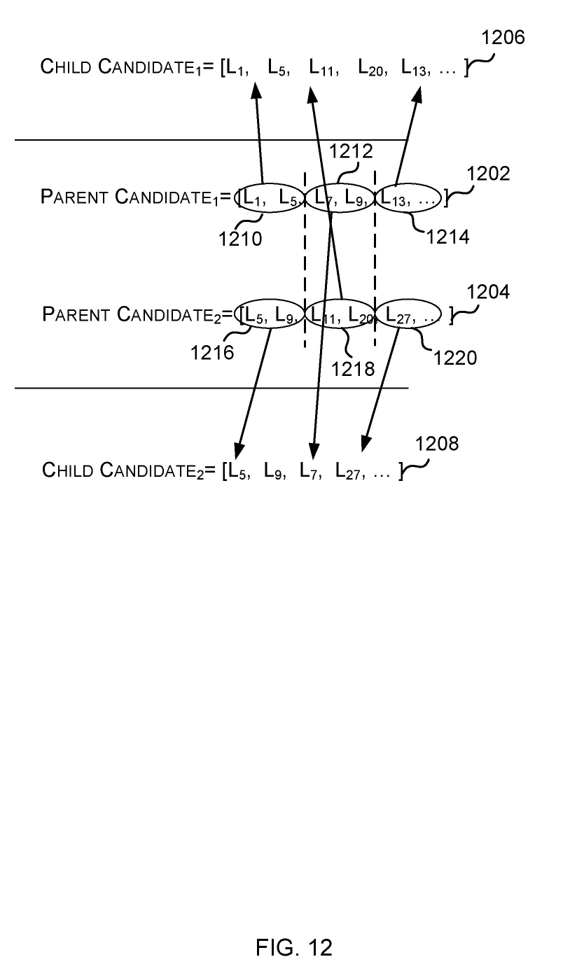

In some cases, the child candidate network topologies may be generated from the parent candidate network topologies by mating or combining the parent candidate network topologies using a known technique such as, but not limited to crossover. In some cases mating may comprise taking portions of multiple parent candidate network topologies and combining them to form a new child candidate network topology. An example of generating child candidate network topologies by mating or combining parent candidate network topologies will be described with reference to FIG. 12.

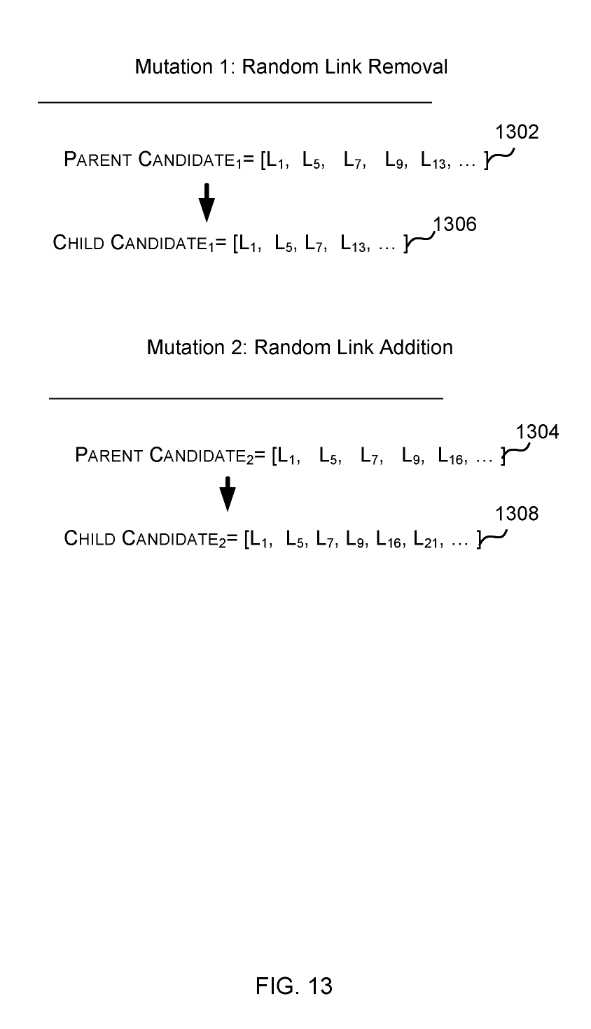

In other cases, the child candidate network topologies may be generated by mutating the parent candidate network topologies. As is known to those of skill in the art, mutation involves altering a parent candidate network topology. In some cases this may comprise randomly removing elements (e.g. links) from the parent candidate network topology. In other cases this may comprise randomly adding elements (e.g. links) to the parent candidate network topology. An example of generating child candidate network topologies through mutation will be described with reference to FIG. 13.

In yet other cases, the child candidate network topologies may be generated through both mutation and mating. For example, parent candidate network topologies may be mated to produce one or more mated candidate network topologies, the mated candidate network topologies may then be mutated to form the child network topologies. Once the child candidate network topologies have been generated the method 1100 proceeds to block 1107.

At block 1107, capacity values are assigned to the links of the child network topologies generated at block 1106 in accordance with the methods described above. Once the capacity values have been assigned the method 1100 proceeds to block 1108.

At block 1108, the child candidate network topologies generated at block 1106 are evaluated (e.g. by the candidate evaluation module 412). In some cases evaluation comprises determining a fitness value, as described above, for each child candidate network topology. Once the child candidate network topologies have been evaluated, the method 1100 proceeds to block 1110.

At block 1110, the candidate generation module 404 adds the child candidate network topologies to the set of candidate network topologies. For example, if the set of candidate network topologies obtained in block 1102 comprised fifty candidate network topologies and two child candidate network topologies are generated then the updated set of candidate network topologies will comprise fifty-two candidate network topologies. Once the child candidate network topologies are added to the set of candidate network topologies, the method 1100 proceeds to block 1112.

At block 1112, the candidate generation module 404 removes X candidate network topologies from the combined set of candidate network topologies where X is the number of child candidate network topologies generated at block 1106. The X candidate network topologies may be selected on the basis of being the “worst” or “weakest” candidate network topologies or using other criteria, such a random selection criteria

In some cases selecting and removing the “worst” or “weakest” candidate network topologies may comprise ranking the candidate network topologies in the combined set based on their associated fitness value and removing the X candidate network topologies with the worst (e.g. lowest) fitness values. In other cases, the candidate generation module 404 is configured to probabilistically remove the “worst” or “weakest” candidate network topologies. In particular the candidate network topologies with the worst (e.g. lowest) fitness values based on a removal probability which is proportional to their fitness value are removed from the set of candidate network topologies. In either case, if the set of candidate network topologies obtained in block 1102 comprised fifty candidate network topologies, two child network topologies are generated and added to the set, the two worst (e.g. based on fitness values or removal probability) are removed from the set to bring the total number of candidate network topologies in the set back to fifty.

If the X candidate network topologies are selected based on random selection, then X random candidate network topologies will be removed from the set. Optionally, the best N (where N is less than M) candidate network topologies may be guaranteed to survive (i.e. remain in the set) and the random selection may only be based on the remainder.

It will be evident to a person of skill in the art that there are other methods that may be used to determine which candidate network topologies survive to the next generation. Once X candidate network topologies have been removed from the set, the method 1100 ends.

Reference is now made to FIG. 12 which illustrates an example of generating child candidate network topologies by mating or combining parent candidate network topologies. In the example, two parent candidate network topologies 1202 and 1204 are selected from the set of candidate network topologies 406. As described above the parent candidate network topologies may be selected from the set of candidate network topologies based on their quality (e.g. based on their fitness value) or they may be selected using other criteria or methods (e.g. they may be randomly selected).

Two child candidate network topologies 1206 and 1208 are then generated by combining aspects (e.g. links) of the two parent candidate network topologies 1202 and 1204 so that the child candidate network topologies 1206 and 1208 comprise a combination of links from both parent candidate network topologies 1202 and 1204. In particular, in the example shown in FIG. 12 each of the two parent candidate network topologies 1202 and 1204 are divided into three parts 1210, 1212, 1214 and 1216, 1218, 1220. The first and third parts 1210 and 1214 of the first parent candidate network topology 1202 are combined with the second part 1218 of the second parent candidate network topology 1204 to form the first child candidate network topology 1206. Then the second part 1212 of the first parent candidate network topology 1202 is combined with the first and third parts 1216 and 1220 of the second parent candidate network topology 1204 to form the second child candidate network topology 1208. This technique is called crossover as different parts of a parent candidate network topology are sent to different child candidate network topologies.

It can be seen that any duplication of links in a child candidate network that result through this process may be removed so that a child candidate network topology does not contain a particular link more than once. For example, both the first part 1216 of the second parent candidate network topology 1204 and the second part 1212 of the first parent candidate network topology 1202 comprise L₉, but L₉ is only listed once in the second child candidate network topology 1208.

Although FIG. 12 illustrates generating child candidate network topologies by combining two parent candidate network topologies, it will be evident to a person of skill in the art that the method could be similarly applied to generate child candidate network topologies by combining more than two parent candidate network topologies. Similarly, although FIG. 12 illustrates a two-point crossover, it will be evident to a person of skill in the art that any number of crossover points may be used.

Reference is now made to FIG. 13 which illustrates an example of generating child candidate network topologies by mutating parent candidate network topologies. In the example shown in FIG. 13 two parent candidate network topologies 1302 and 1304 are selected from the set of candidate network topologies 406. As described above the parent candidate network topologies may be selected from the set of candidate network topologies based on on their quality (e.g. based on their fitness value) or they may be selected used another criteria or method (e.g. they may randomly selected).

Two child candidate network topologies 1306 and 1308 are then created from a mutation of one of the parent candidate network topologies 1302 and 1304. As described above mutation comprises altering the parent candidate network topology in some manner. In the example shown in FIG. 13 the first child candidate network topology 1306 is created from the first parent candidate network topology through a mutation process that randomly removes one or more links from the parent candidate network topology. For example, the first child candidate network topology 1306 is generated by removing the fourth link (L₉) from the first parent candidate network topology 1302. Other mutation methods may randomly remove more than one link and/or the number of links removed may be randomly selected.

In the example shown in FIG. 13, the second child candidate network topology 1308 is created from the second parent candidate network topology through a mutation process that randomly adds a link to the parent candidate network topology. For example, the second child candidate network topology 1308 comprises all of the links of the second parent candidate network topology plus a new link (L₂₁). Other mutation methods may randomly add more than one link and/or the number of links added may be randomly selected.

In other cases links may be both added and removed. For example, mutating may comprise removing a link in the parent candidate network topology 1302 or 1304 to form a child candidate network topology and adding a link to the child candidate network topology that is not already in the child candidate network topology.

It will be evident to a person of skill in the art that FIG. 13 illustrates example mutation techniques and other known mutation techniques may also be used. For example, other mutation techniques may use heuristics to mutate a parent candidate network topology to generate one or more child candidate network topologies.

Reference is now made to FIG. 14 which illustrates an example stop condition which may be used by the stop condition module 416 to determine when to stop the iterative process (e.g. when a sufficiently optimum network topology has been identified). As described above, one stop condition that the stop condition module 416 may use to determine that a sufficiently optimum network topology has been identified is when the best fitness value for the set of candidate network topologies is sufficiently close to the predicted optimum fitness value. FIG. 14 show a graph 1400 of the best fitness value 1402 over time (e.g. as more iterations are performed).

It can be seen in FIG. 14 that as more iterations are performed the better the best fitness value becomes gradually approaching an asymptote 1404 that represents the optimum or best fitness value. There will be a point in the iterative process where the best fitness value will be within a certain percentage (e.g. 5%) 1406 of the optimum or best fitness value 1404. In some cases the stop condition module 416 is configured to determine a stop condition is satisfied if the best fitness value is within the predetermine percentage (e.g. 5%) 1406 of the optimum fitness value.

In some cases the stop condition module 416 is configured to, after each iteration (e.g. after each evolution step is completed), estimate the asymptote 1404 (e.g. the optimum or best fitness value) and compare the current best fitness value to the calculated asymptote 1404 to determine if the current best fitness value is within the predetermined percentage of the asymptote 1404. The estimation of the asymptote 1404 becomes more accurate over time (as more iterations are performed) as there is more data from which to calculate the asymptote 1404.

In some cases the best fitness as a function of time/iterations 1402 is approximated as a rational function, R. As it known to those of skill in the art a rational function is the ratio of two polynomials. An example rational function, R, is illustrated in equation (4)

$$R = \frac{{A}_{0} + {A}_{1} * X + {A}_{2} * {X}^{2}}{1 + {B}_{1} * X + {B}_{2} * {X}^{2}} \qquad ( 4 )$$

Where the maximum exponent of the two polynomials is equal (e.g. in equation (4) the highest exponent for each of the polynomials is two) then the asymptote 1404 of the curve 1402 (the fitness at infinite iterations) is equal to the ratio of the coefficients of the maximum exponents. This is illustrated in equation (5).

$$Asymptote = \frac{{A}_{2}}{{B}_{2}} = Optimum Best Fitness \qquad ( 5 )$$

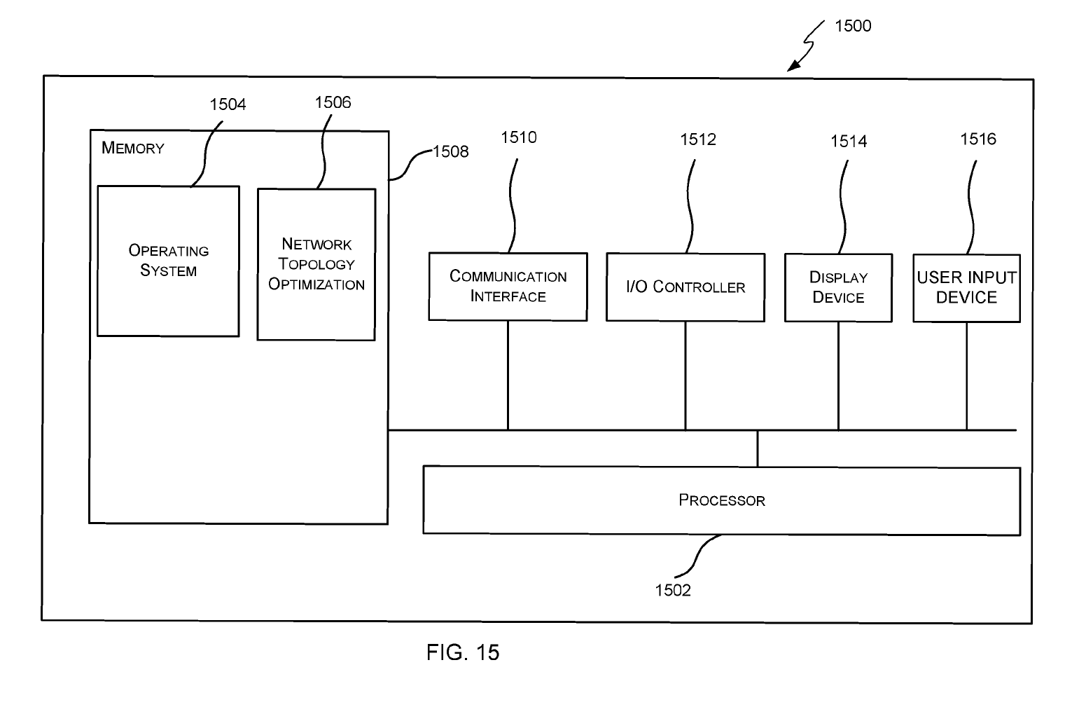

The two polynomial coefficients can be computed from a least squares method from the best fitness value after each iteration. Therefore, the more iterations, the more data (e.g. the more best fitness values) there is to estimate the curve and thus the more accurate the coefficients (and thus the more accurate the asymptote). Reference is now made to FIG. 15 which illustrates various components of an exemplary computing-based device 1500 which may be implemented as any form of a computing and/or electronic device, and in which embodiments of the methods and systems described herein may be implemented.

Computing-based device 1500 comprises one or more processors 1502 which may be microprocessors, controllers or any other suitable type of processors for processing computer executable instructions to control the operation of the device in order to identify an optimum network topology for satisfying one or more service requirements under one or more constraints. In some examples, for example where a system on a chip architecture is used, the processors 1502 may include one or more fixed function blocks (also referred to as accelerators) which implement a part of the method of identifying an optimum network topology in hardware (rather than software or firmware). Platform software comprising an operating system 1504 or any other suitable platform software may be provided at the computing-based device to enable application software 1506, such as network topology optimization software to be executed on the computing based device 1500.

The computer executable instructions may be provided using any computer-readable media that is accessible by computing based device 1500. Computer-readable media may include, for example, computer storage media such as memory 1508 and communications media. Computer storage media (i.e. non-transitory machine readable media), such as memory 1508, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (i.e. non-transitory machine readable media, e.g. memory 1508) is shown within the computing-based device 1500 it will be appreciated that the storage may be distributed or located remotely and accessed via a network or other communication link (e.g. using communication interface 1510).

The computing-based device 1500 also comprises an input/output controller 1512 arranged to output display information to a display device 1514 which may be separate from or integral to the computing-based device 1500. The display information may provide a graphical user interface. The input/output controller 1512 is also arranged to receive and process input from one or more devices, such as a user input device 1516 (e.g. a mouse or a keyboard). In an embodiment the display device 1514 may also act as the user input device 1516 if it is a touch sensitive display device. The input/output controller 1512 may also output data to devices other than the display device, e.g. a locally connected printing device (not shown in FIG. 15).

The term ‘processor’ and ‘computer’ are used herein to refer to any device, or portion thereof, with processing capability such that it can execute instructions. The term ‘processor’ may, for example, include central processing units (CPUs), graphics processing units (GPUs or VPUs), physics processing units (PPUs), digital signal processors (DSPs), general purpose processors (e.g. a general purpose GPU), microprocessors, any processing unit which is designed to accelerate tasks outside of a CPU, etc. Those skilled in the art will realize that such processing capabilities are incorporated into many different devices and therefore the term ‘computer’ includes set top boxes, media players, digital radios, PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Memories storing machine executable data for use in implementing disclosed aspects can be non-transitory media. Non-transitory media can be volatile or non-volatile. Examples of volatile non-transitory media include semiconductor-based memory, such as SRAM or DRAM. Examples of technologies that can be used to implement non-volatile memory include optical and magnetic memory technologies, flash memory, phase change memory, resistive RAM.

A particular reference to “logic” refers to structure that performs a function or functions. An example of logic includes circuitry that is arranged to perform those function(s). For example, such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnect, by way of example. Such elements may be provided as custom circuits or standard cell libraries, macros, or at other levels of abstraction. Such elements may be interconnected in a specific arrangement. Logic may include circuitry that is fixed function and circuitry can be programmed to perform a function or functions; such programming may be provided from a firmware or software update or control mechanism. Logic identified to perform one function may also include logic that implements a constituent function or sub-process. In an example, hardware logic has circuitry that implements a fixed function operation, or operations, state machine or process.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1.-51. (canceled)

52. A system to determine an optimum network topology to support a plurality of service requirements, the system comprising:
a candidate generation module configured to generate a set of candidate network topologies from a set of network resources, and repeatedly evolve the set of candidate network topologies;
a candidate evaluation module configured to repeatedly evaluate each of the candidate network topologies based on one or more user-specified technical constraints and the plurality of service requirements, each service requirement indicating an amount of data to be transmitted from a start node to an end node; and
a stop condition module configured to repeatedly determine if a stop condition is satisfied, and in response to determining the stop condition is satisfied select the best candidate network topology from the set of candidate network topologies based on the evaluation of the candidate network topologies and output the selected candidate network topology as the optimum network topology.

53. The system of claim 52, wherein the set of network resources comprises a plurality of nodes and a plurality of links, each link connecting two of the plurality of nodes.

54. The system of claim 53, wherein each candidate network topology of the set of candidate network topologies comprises a subset of the nodes and links in the set of network resources.

55. The system of claim 54, wherein each candidate network topology is represented by a vector of the links forming the candidate network topology.

56. The system of claim 55, wherein each of the links in the vector is represented by a link identifier.

57. The system of claim 52, wherein evolving the set of candidate network topologies comprises generating at least one additional candidate network topology, adding the at least one additional candidate network topology to the set of candidate network topologies, and removing x candidate network topologies from the set of candidate network topologies, wherein x is the number of additional candidate network topologies generated.

58. The system of claim 57, wherein generating at least one candidate network topology comprises selecting at least one parent candidate network topology from the set of network topologies and generating at least one child candidate network topology from the at least one parent candidate network topology.

59. The system of claim 58, wherein the at least one child candidate network topology is generated from a mutation of one of the parent candidate network topologies.

60. The system of claim 59, wherein each candidate network topology comprises a plurality of links and mutating the parent candidate network topology comprises randomly removing at least one of the links of the parent candidate network topology.

61. The system of claim 59, wherein each candidate network topology comprises a plurality of links and mutating the parent candidate network topology comprises randomly adding a link to the parent candidate network topology.

62. A computer-implemented method to determine a network topology to support a plurality of service requirements, the method comprising:
generating a set of candidate network topologies from a set of network resources;
repeatedly evaluating each of the candidate network topologies based on one or more user-specified technical constraints and the plurality of service requirements, each service requirement indicating an amount of data transmitted from a start node to an end node;
repeatedly determining if a stop condition is satisfied;
in response to determining the stop condition is not satisfied, evolving the set of candidate network topologies;
in response to determining the stop condition is satisfied, selecting the best candidate network topology from the set of candidate network topologies based on the evaluation of the candidate network topologies; and
outputting the selected candidate network topology.

63. The method of claim 62, wherein the set of network resources comprises a plurality of nodes and a plurality of links, each link connecting two of the plurality of nodes.

64. The method of claim 63, wherein each candidate network topology of the set of candidate network topologies comprises a subset of the nodes and links in the set of network resources.

65. The method of claim 64, wherein each candidate network topology is represented by a vector of the links forming the candidate network topology.

66. The method of claim 65, wherein each of the links in the vector is represented by a link identifier.

67. The method of claim 62, wherein evolving the set of candidate network topologies comprises generating at least one additional candidate network topology, adding the at least one additional candidate network topology to the set of candidate network topologies, and removing x candidate network topologies from the set of candidate network topologies, wherein x is the number of additional candidate network topologies generated.

68. The method of claim 67, wherein generating at least one candidate network topology comprises selecting at least one parent candidate network topology from the set of network topologies and generating at least one child candidate network topology from the at least one parent candidate network topology.

69. The method of claim 68, wherein the at least one child candidate network topology is generated from a mutation of one of the parent candidate network topologies.

70. The method of claim 69, wherein each candidate network topology comprises a plurality of links and mutating the parent candidate network topology comprises randomly removing at least one of the links of the parent candidate network topology.

71. A computer readable storage medium having encoded thereon computer readable program code which when run by a computer causes the computer to perform the method of claim 62.
